(19) United States
(12) Patent Application Publication
(10) Pub. No.: US 2019/0321259 A1
(43) Pub. Date: Oct. 24, 2019

(54) Acupuncture Foot Massage Device

(71) Applicant: Guanghua Zhou, Xiamen (CN)

(72) Inventor: Guanghua Zhou, Xiamen (CN)

(73) Assignee: Xiamen Emoka Health Science & Technology Co., Ltd, Xiamen (CN)

(21) Appl. No.: 16/012,375

(22) Filed: Jun. 19, 2018

(30) Foreign Application Priority Data
Apr. 20, 2018 (CN) 201820574706.2

(51) Int. Cl. A61H 39/08; A61H 7/00

(52) U.S. Cl. CPC A61H 39/08; A61H 2015/0028; A61H 7/007

(57) ABSTRACT

The present application discloses a novel acupuncture foot massage device, comprising a housing, a motor, a gear assembly, an acupuncture box and a massage disc, wherein the gear assembly drives the massage disc to rotate and perform kneading massage and the curved surface disc to move acupuncture needles up and down to perform acupuncture massage on the foot, such that entire set of the acupuncture points of the foot are adequately massaged.

### CROSS-REFERENCE

This application claims the priority of the CN Patent Application No. 201820574706.2 filed on Apr. 20, 2018, the entirety of which is hereby incorporated by reference.

### TECHNICAL FIELD

The present invention relates to a massage device, and particularly, to an novel acupuncture foot massage device.

### BACKGROUND

A foot massage device may be an advanced health care appliance integrating massage, meridian, holography and reflexology. It is simple, effective, free of side effect and can prevent many heath-related problems. According to traditional Chinese medicine, all of the individual internal organs of the human body have its corresponding related points in the feet. There are more than 60 acupuncture points on the body part below the ankle, and massaging them by foot massage device may increase energy and blood flow and warm the internal organs. Foot massaging before going to bed may calm the mood and allow better sleep. It may be an ideal method for adjusting the body and relieving daily living pressure through the use of foot massage device.

However, the conventional foot massage devices only offer simple massage acts, providing insufficient stimulation to the foot.

### SUMMARY OF THE INVENTION

The present invention discloses a novel acupuncture foot massage device with improved massage effects. The acupuncture foot massage device adopts the following technical scheme:

A new acupuncture foot massage device comprises a housing, a motor, a gear assembly, an acupuncture box and a massage disc. The housing includes a chamber for installing the motor and the gear assembly. A control panel is installed on the housing and electrically connected with the motor, controls the motor which in turn drives the gear assembly. The top of the housing is constructed with front, middle and rear through-holes in corresponding to the front, the center and the rear part of a foot.

An acupuncture box is installed fixedly inside the front and rear through-holes, and acupuncture needles of an inner ring and an outer ring are installed in the acupuncture box in the way that the needles can move up and down; a curved face disc is installed at the bottom of the acupuncture box, and the curved face disc has an inner ring curved face and an outer ring curved face in corresponding to the inner ring needles and the outer ring needles.

A massage disc is flexibly installed in the middle through-hole and is constructed with a massaging head on the top; the massage disk and the curved face disc are mounted on a corresponding transmission shaft of the gear assembly which drives the massage disc to perform kneading massage and the curved surface disk to rotate and cause the inner ring needles and outer ring needles to move up and down to perform acupuncture massage.

The top surface of the massage disc is inclined with an angle, a massage head is installed on this inclined surface.

The acupuncture box is provided with needle holes, the inner ring needles and outer ring needles are configured to move alternatively inside the needle holes, the end of the acupuncture box where the inner ring needles and outer ring needles are located is a bigger end and the bigger end falls on the curved face disc.

A light panel is installed inside the acupuncture box and is electrically connected with the control panel which controls the light panel to warm through infrared light and provide physical therapy of the acupuncture massage area.

Both the inner and outer ring of the curved surface disk are wave-shaped, and the wave peak and the wave trough of the inner ring are in staggered arrangement with those of the outer ring.

Each wave of the inner ring has a height difference of 7.5 mm between the wave peak and the wave trough, so that the up and down travel distance is about 7.5 mm for the inner ring acupuncture needles.

Each wave of the outer ring has a height difference of 7.5 mm between the wave peak and the wave trough, so that the up and down travel distance is about 7.5 mm for the outer ring acupuncture needles.

An air pump is installed in the housing chamber and electrically connected with the control panel which controls the operation of the air pump. A leather air bag is installed at the housing top, the opening of the air bag is connected with the air pipe of the air pump which inflates and deflates the air bag to provide an air pressured massage on the instep of the foot.

The housing is formed by snapping together the upper housing and the lower housing, the upper housing is constructed with a front, a middle and rear through-holes, and the lower housing forms a gear groove. The gear groove is shielded by a gear cover, the gear groove and the gear cover form a gear case, and the gear assembly is installed inside the gear case. The gear assembly and the transmission shafts that are corresponding to the massage disk and the curved surface disk pass through and project from the shaft holes in the gear cover, and the acupuncture box is fastened on the gear cover.

A supporting holder is installed on the upper housing and the control panel is installed on the holder so that it is easy to operate.

The top of the housing is provided with corresponding front, middle and rear through-holes in corresponding to the sections of the soles of both the left and the right foot.

Structured as such, the control panel will control the motor which will drive the gear assembly to rotate, the gear assembly will rotate the massage disc via a transmission shaft which will perform kneading massage on the middle section of the sole, the transmission shaft of the gear assembly will also drive the curved surface disc to rotate, causing the inner ring needles and the outer ring needles to move up and down to perform acupuncture massage on the front section and the rear section of the sole, providing adequate massaging on the various acupuncture points of the entire sole.

Thus the present acupuncture foot massage device provides multiple massaging performances including acupuncture massage and kneading massage, significantly improving the effects of massaging.

The present invention will be further detailed in combination with attached drawings and specific embodiments.

### BRIEF DESCRIPTION OF DRAWINGS

The disclosed application will be described with reference to the accompanying drawings, which show important sample embodiments of the invention and which are incorporated in the specification hereof by reference, wherein:

FIG. 1 is an exploded view of an example acupuncture foot massage device in accordance with this application;

FIG. 2 is a perspective view of an example acupuncture foot massage device without the top air bag in accordance with this application;

FIG. 3 is a cross-sectional view of an example massage disc in accordance with this application;

FIG. 4 is a top view of an example curved surface disc in accordance with this application;

FIG. 5 is an example A-A sectional view of the curved surface disc of FIG. 4;

FIG. 6 is an example B-B sectional view of the curved surface disc of FIG. 4;

FIG. 7 is an exploded view of the assembly of an example acupuncture box and a curved surface disc in accordance with this application;

FIG. 8 is a sectional view of the assembly of the acupuncture box and the curved surface disc in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

Description of mark numbers: housing 1, front through-hole 11, middle through-hole 12, rear through-hole 13, upper housing 14, lower housing 15, gear groove 16, gear cover 17, shaft hole 171, holder 18; motor 2; gear assembly 3, transmission shaft 31; acupuncture box 4, inner ring needles 41, outer ring needles 42, curved surface disc 43, inner ring curved face 431, outer ring curved surface 432, light panel 44; massage disc 5, massage head 51; control panel 6; air pump 7; leather air bag 8.

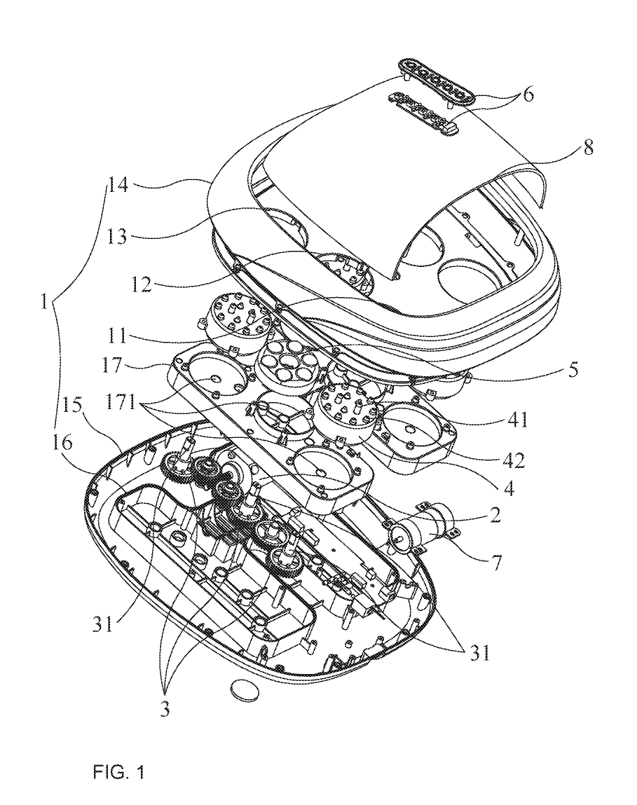

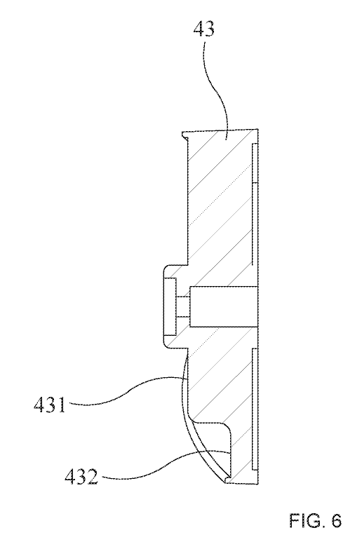

As show in FIGS. 1-8, the disclosed acupuncture foot massage device comprises a housing 1, a motor 2, a gear assembly 3, an acupuncture box 4 and a massage disc 5, an air bag 8, and a control panel 6.

In reference to FIG. 1, housing 1 has a chamber for installing a motor 2 and a gear assembly 3. A control panel 6 is installed on housing 1 and is electrically connected with motor 2. Motor 2 drives the gear assembly 3 in which the output worm shaft of motor 2 drives a bevel gear which in turn further drive a spur gear. In addition, gear assembly 3 may include other gear structures not shown in the figures.

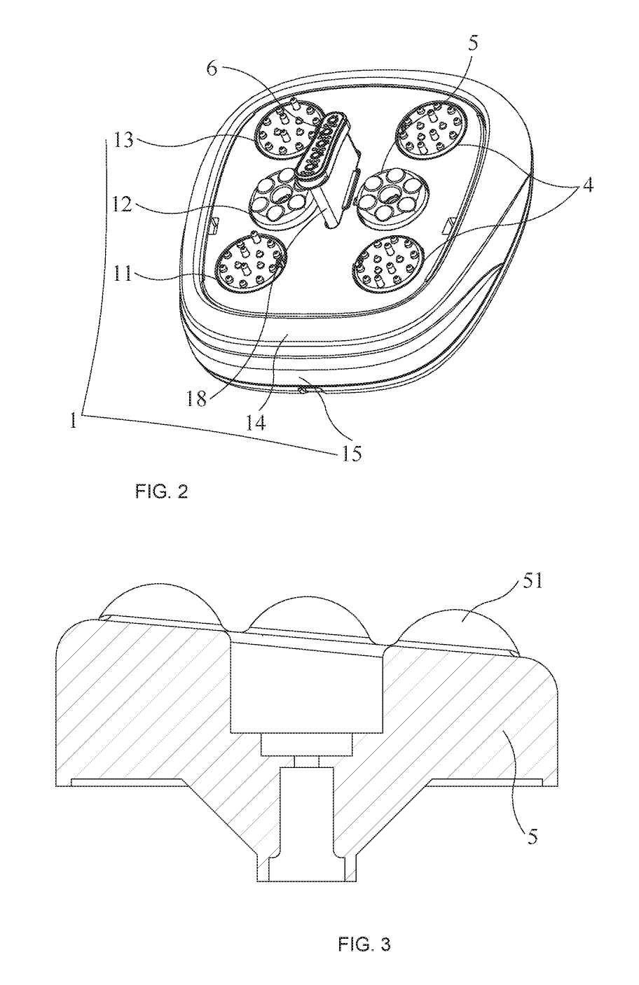

In reference to FIG. 1 and FIG. 2, the top of housing 1 is constructed with front through-holes 11, middle through-holes 12 and rear through-holes 13 in corresponding to the front sole, the center and the rear sole of the foot. Acupuncture box 4 is installed fixedly inside front-holes 11 and rear through-holes 13.

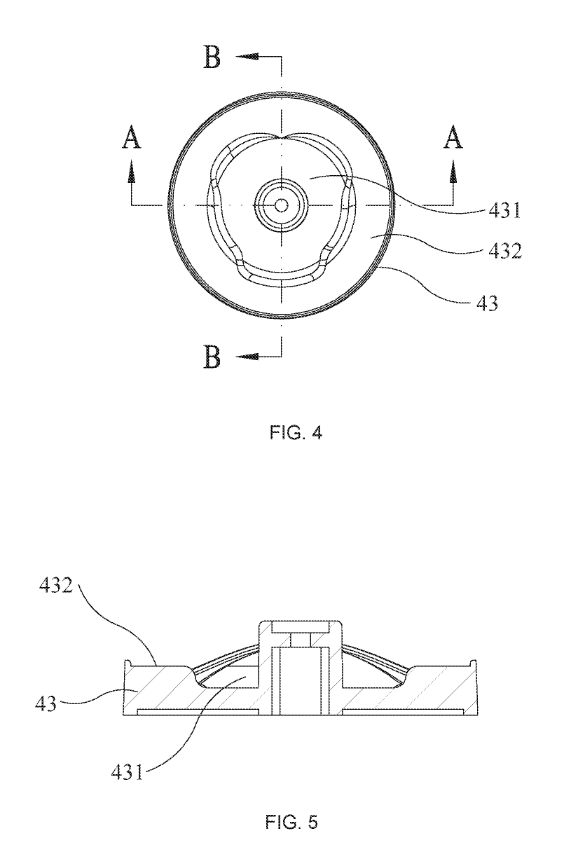

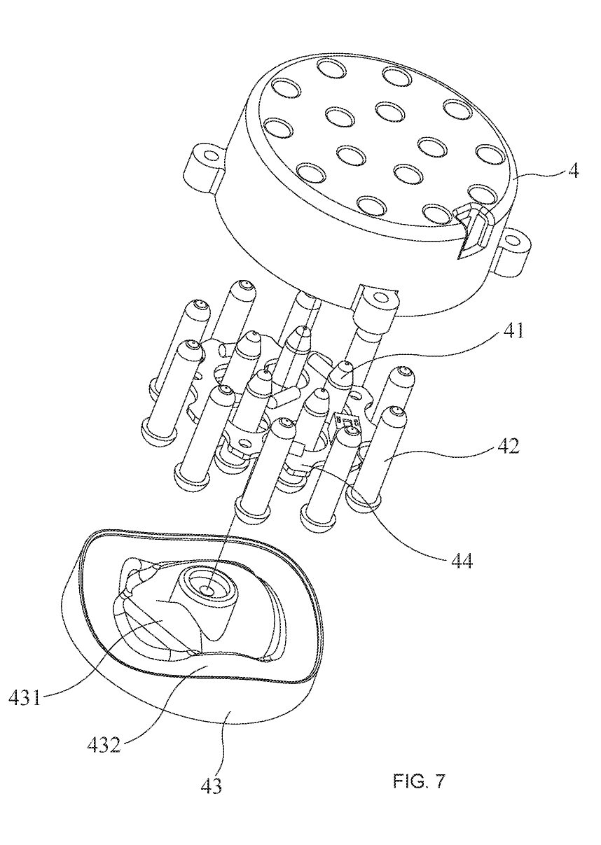

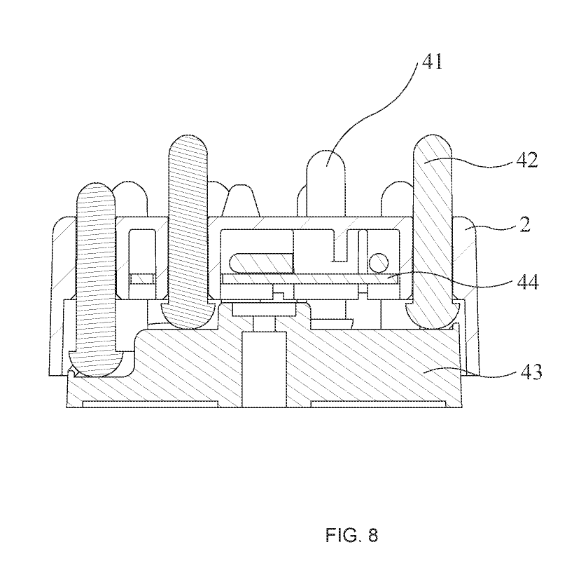

In reference to FIG. 7, the inner ring acupuncture needles 41 and the outer ring acupuncture needles 42 are installed in acupuncture box 4 such that the needles 41 and 42 can move up and down. A curved surface disc 43 is installed at the bottom of the acupuncture box 4, and the curved surface disc 43 has an inner ring curved surface 431 and an outer ring curved surface 432 as shown in FIG. 4 and FIG. 5 in corresponding respectively to inner ring needles 41 and outer ring needles 42.

In reference to FIGS. 2 and 3, moving massage disc 5 is installed in the middle through-hole 12 and is provided with a massage head 51 on the top. As shown in FIG. 1, massage disc 5 and the curved surface disc 43 are fixed on the corresponding transmission shafts 31 of the gear assembly 3 and the gear assembly 3 will drive the massage disc 5 to perform kneading massage and the curved surface disk 43 will make the inner ring needles 41 and outer ring needles 42 to move up and down to perform acupuncture massage.

In operation, control panel 6 will direct motor 2 to drive gear assembly 3, and gear assembly 3 will rotate massage disc 5 via transmission shaft 31 and perform kneading massage on the middle sole of the foot. Transmission shaft 31 will also rotate the curved surface disc 43 which will make the inner ring needles 41 and the outer ring needles 42 to up and down and perform acupuncture massage on the front sole and the rear sole of the foot, providing a complete massage on all acupuncture points of the entire sole of the foot.

Moreover, as shown in FIG. 3, the top of the massage disc 5 is an inclined plane and massage head 51 is installed on it which comprise multiple round bases for push kneading about the center sole section of the foot.

In addition, as shown in FIGS. 4, 5 and 6, both the inner curved surface 431 and outer ring curved surface 432 of the curved surface disk 43 are wave-shaped, and the waving peak and trough of the inner ring curved face 431 are in fully staggered arrangement with those of the outer ring curved face 432. Acupuncture box 4 is provided with needle holes, the inner ring needles 41 and outer ring needles 42 move alternatively in the needle holes, the end of the acupuncture box 4 where the inner ring needles 41 and outer ring needles 42 are located on larger end which falls on the curved surface disc 43.

As shown in FIGS. 7 and 8, in the preferred embodiment, the inner ring curved surface 431 of the curved face disc 43 is of wave shape and there is a height difference (d) between the wave peak and the wave bottom is about 7.5 mm, so that the up and down travel is about 7.5 mm for the inner ring acupuncture needles 41. Similarly the outer ring curved surface 432 of the curved face disc 43 is of wave shape and there is a height difference (d) is about 7.5 mm between wave peak and wave bottom, so that the up and down travel is about 7.5 mm for the outer ring acupuncture needles 42.

A light panel 44 is installed in between inner ring acupuncture needles 41 and outer ring acupuncture needles 42 in the acupuncture box 4 and electrically connected with control panel 6, and control panel 6 controls the work of the light panel 44. The light panel 44 generates heat in operation to perform heating and infrared physical therapy of the acupuncture massage area (front sole and rear sole).

As shown in FIG. 1, an air pump 7 is installed in one chamber of the housing 1 and is electrically connected with the control panel 6, and control panel 6 also controls the operation of air pump 7; a leather or composite air bag 8 is installed at the top of the housing 1 and is connected to the air pipe of air pump 7. The inflation and deflation of air bag 8 further provide air pressure massage on the instep of the foot.

In order to assemble all parts easily, housing 1 comprises an upper housing 14 and a lower housing 15 which are buckled together to form a full housing 1. Upper housing 14 is constructed with front through-holes 11, middle through-holes 12 and rear through-holes 13, while lower housing 15 includes a gear groove 16, gear groove 16 is shielded by a gear cover 17. Gear groove 16 and gear cover 17 form a gear case wherein gear assembly 3 is installed. Gear assembly 3 and the transmission shafts 31 in corresponding to massage disk 5 and curved surface disc 43 pass through shaft holes 171 and project out from gear cover 17. The acupuncture box 4 is locked on the gear cover 17.

For different foot, front through-holes 11, middle through-holes 12 and rear through-holes 13 configured on the top of the housing 1 are constructed in corresponding to the sole shape of the left foot or the right foot or to both.

To facilitate operation, a supportive holder 18 is installed on the upper housing 14 and the control panel 6 is installed on supportive holder 18.

The acupuncture foot massage device will simultaneously provide a plurality of massage actions to the foot: acupuncture massage, kneading massage, heating physical therapy and air pressure massage, thus greatly improving the massaging effects on the foot.

What is claimed is:

1. An acupuncture foot massage device, comprising:
a housing having a top section wherein a plurality of front through-holes, middle through-holes and rear through-holes are constructed on the top section in corresponding to the front sole section, the middle sole and the rear sole section of a human foot;
a motor;
a gear assembly;
an acupuncture box;
a massage disc;
a plurality of acupuncture needles arranged as an inner ring and an outer ring being installed inside the acupuncture box such that the acupuncture needles can move up and down; and
a curved surface disc being installed at the bottom of the acupuncture box, having an inner ring curved surface and an outer ring curved surface
in corresponding to the inner ring needles and the outer ring needles; wherein the housing has a chamber for installing the motor and the gear assembly, the acupuncture box is installed fixedly in the front though-holes and the rear through-holes, the massage disc is flexibly installed in the middle through-hole and is provided with a massage head on the top section; the massage disk and the curved surface disc are fixed on the corresponding transmission shafts of the gear assembly, and the gear assembly drives the massage disc to perform kneading massage and the curved surface disk to move the inner ring needles and outer ring needles up and down in performing acupuncture massage.

2. The acupuncture foot massage device of claim 1, further comprising a control panel that is electrically connected with and controls the motor which drives the gear assembly.

3. The acupuncture foot massage device of claim 1, wherein the massage disc has a top section that is configured in an inclined shape and a massage head is installed thereon.

4. The acupuncture foot massage device of claim 1, wherein the acupuncture box is configured a first end and a second end, the first end being bigger than the second end, the first end being configured with needle holes, the plurality of the acupuncture needles of the inner ring and of outer ring being configured to move alternatively in the needle holes, the first end fits on the curved surface disc.

5. The acupuncture foot massage device of claim 1, further comprising a light panel being installed in the acupuncture box wherein said light panel is configured for infrared heating.

6. The acupuncture foot massage device of claim 1, wherein both the inner and outer ring curved surfaces of the curved surface disk have a wave peak and a wave trough, the wave peak and the wave trough of the inner ring curved surface are in staggered arrangement with the wave peak and the wave trough of the outer ring curved surface.

7. The acupuncture foot massage device of claim 6, wherein there is a height difference of about 7.5 mm between the wave peak and wave the trough, forming an up-down travel distance of about 7.5 mm for acupuncture needles.

8. The acupuncture foot massage device of claim 1, further comprising an air pump that is installed in the housing, and an air bag being installed at the top section of the housing and the air bag being connected to the air pump via an air pipe whereby air bag's inflation and deflation provide air pressure massage.

9. The acupuncture foot massage device of claim 1, wherein the housing is formed by buckling of an upper housing and a lower housing, the upper housing is provided with the front through-holes, the middle through-holes and rear through-holes, and the lower housing forms a gear groove, and the gear groove is shielded by a gear cover, the gear groove and the gear cover form a gear case, and the gear assembly is installed in the gear case; the gear assembly and transmission shafts in corresponding to the massage disk and the curved surface disk project through from a plurality of shaft holes in the gear cover, and the acupuncture box is fastened on the gear cover.

10. The acupuncture foot massage device of claim 9, further comprising a supportive holder installed on the upper housing for mounting a control panel.

11. The acupuncture foot massage device of claim 9, wherein that the upper housing is provided with a front through-hole, a middle through-hole and rear through-holes in corresponding to both the left and the right foot.
